(19) United States
(12) Patent Application Publication
(10) Pub. No.: US 2009/0150195 A1
(43) Pub. Date: Jun. 11, 2009

(54) METHOD AND SYSTEM FOR CREATING STRUCTURE FOR INTERNAL CONTROLS

(76) Inventor: Kevin McCreary, Pearland, TX (US)

Correspondence Address: Michael A. Rahman;GARDERE WYNNE SEWELL LLP, 1601 Elm Street, Suite 3000, Dallas, TX, 75201-4761, US

(21) Appl. No.: 11/951,022

(22) Filed: Dec. 5, 2007

(51) Int. Cl. G06Q 10/00

(52) U.S. Cl. 705/7

(57) ABSTRACT

A method and system for creating and managing a control structure for compliance with one or more compliance regimes by an entity is disclosed. The method is used for analyzing risks associated with deficiencies in compliance and for generating reports related to the compliance status. The method includes specifying one or more master structures for the entity, wherein specifying the master structure includes specifying one or more processes associated with the master structure, specifying one or more objectives for the processes, identifying one or more risks associated with the objective, and identifying one or more controls to mitigate the risks.

### TECHNICAL FIELD OF THE INVENTION

The invention relates to internal controls for compliance with one or more compliance regimes, and more specifically the invention relates to a method and system for creating and managing a structure for internal controls for compliance with one or more compliance regimes by an entity.

### BACKGROUND OF THE INVENTION

Today businesses face multiple compliance mandates from compliance regimes. The compliance mandates may relate to financial reporting, environmental, workplace safety, labor and employment or other areas. The compliance regimes may be governmental agencies such as SEC, EPA, OSHA, DOJ or other governmental branches.

The compliance mandates generally impose corporate governance rules requiring management to establish and maintain internal controls for business processes. The internal controls are necessary for management to properly manage the business processes. Failure to properly manage the business processes may have negative ramifications. For example, a failure by a publicly traded company to accurately disclose its financials in its earnings report may result in sanctions imposed by the SEC. Also, a failure by a chemical company to properly dispose hazardous chemicals may result in penalties by the EPA.

Most businesses attempt to manually manage the internal controls established to comply with various mandates. However, many internal controls are required to comply with multiple mandates, businesses experience difficulty in manually managing the internal controls. Many businesses have realized that it is difficult to manually monitor that the business processes have been managed properly. Also, businesses have realized that when the internal controls are manually managed, it is sometimes difficult to prove compliance with the mandates.

A few applications have been offered for managing the internal controls, but these applications have many disadvantages. Most existing applications are not flexible enough to adapt to an entity's organizational structure and adapt to changes to the entity's organizational structure. Most existing applications require customization before they can be adapted to an entity's structure and internal controls. Some existing applications do not provide comprehensive document management and also do not contain a facility to test internal controls. Also, most existing applications are compliance regime-specific. For example, a solution for compliance with Sarbanes-Oxley regulations is unsuited for compliance with EPA or OSHA regulations.

Accordingly, there exists a need for an integrated and comprehensive solution to the foregoing problems. There exists a need for an automated solution for creating a structure that provides internal controls for compliance with one or more compliance regimes. There exists a need for an automated solution for creating and managing internal controls, document management and risk assessments.

### SUMMARY

A system and method allows an entity to establish and manage internal controls for compliance with one or more compliance regimes. The system and method allows the entity to establish a control structure for compliance with one or more compliance regimes. The system assists the entity to analyze risks associated with deficiencies in compliance and to generate reports related to the compliance.

The system includes a processor enabled to receive a plurality of user inputs. The user inputs are related to the management of compliance and risks. The system further includes a memory connected to the processor. The memory is responsive to the processor to store data received from the processor and to provide data to the processor.

The system, responsive to the user inputs, generates the control structure for specifying one or more master structures for the entity. The master structure is a template, which allows the entity to define various components of the master structure. The master structure allows the entity to specify one or more processes associated with the master structure. The process may include one or more sub-processes for compliance with the compliance regimes. The master structure allows the entity to specify one or more objectives for the processes. The master structure allows the entity to identify one or more risks associated with the objectives. The risk may prevent achieving the objectives. The master structure allows the entity to identify one or more controls to mitigate the risks. The controls include one or more control steps executed to mitigate the risks.

### BRIEF DESCRIPTION OF THE DRAWINGS

For a more complete understanding of the features, example embodiments and possible advantages of the present invention, reference is now made to the detailed description of the invention along with the accompanying figures and in which:

FIG. 1 is a block diagram of a system in accordance with one example embodiment.

FIG. 2 is a high level flow diagram of the method steps in accordance with one example embodiment.

FIG. 3 is a detailed flow diagram of the method steps of establishing a control structure for compliance with one or more compliance regimes.

FIG. 4 is a flow diagram of the steps associated with conducting tests and generating reports in accordance with one example embodiment.

### DETAILED DESCRIPTION OF THE INVENTION

In one embodiment, a system assists an entity to establish and manage internal controls to comply with one or more compliance mandates imposed by compliance regimes. The specific requirements for compliance mandates may vary from compliance regime to compliance regime, but they generally require a company to implement a control structure to mitigate significant risks. The entity may be a corporation, partnership or any other entity that must comply with one or more compliance regimes.

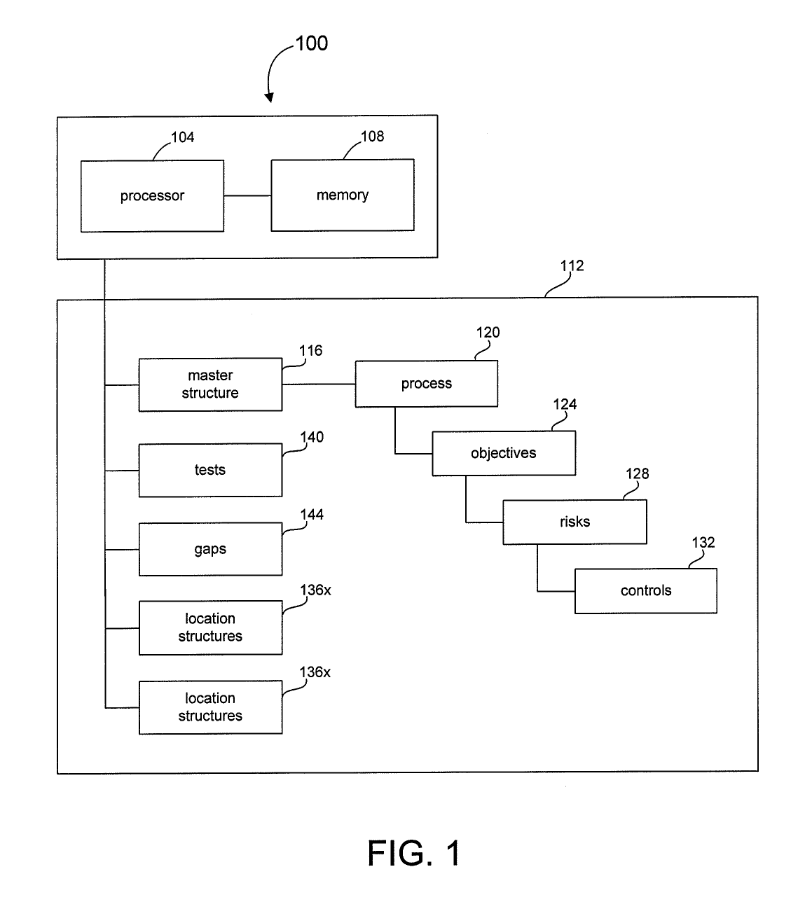

FIG. 1 is a block diagram of a system 100 in accordance with one example embodiment. The system 100 includes a processor 104 enabled to receive a plurality of user inputs. A memory 108 is connected to the processor 104. The memory 108, responsive to the processor 104, stores data received from the processor 104 and provides data to the processor 104.

The system 100 includes a control structure 112, which allows a user to establish internal controls for an entity to comply with compliance regimes. The control structure 112 has a plurality of components organized in a hierarchical form. In one example embodiment, the control structure 112 may have a master structure 116 at the top of the hierarchy. The master structure 116 may represent a template for the entity or may represent a template for a division or a particular line of business of the entity. The control structure 112 may have a plurality of master structures each representing a division or a line of business of the entity.

In one example implementation, the system 100 may have multiple control structures. The entity may decide how to use each control structure. A control structure may represent a discrete business unit (e.g., upstream, downstream, retail, services, etc.) or the control structure may represent a type of compliance regime (e.g., Sarbanes-Oxley, financial reporting, EPA OSHA, personnel). A control structure may also represent an internal project where the entity has its own internal compliance regime. For example, the entity may wish to establish internal controls for the construction of a new facility during which the entity wants to stay on top of all of the risks that might preclude the entity from achieving its objectives during the construction project.

As discussed before, the master structure 116 represents a template of a business process. The template allows the entity (or a user) to specify one or more objectives of the business process (with respect to the given compliance regime), the risks in the business process that would stand in the way of achieving the objectives, and the controls that are designed to mitigate the risks. Under the master structure node (in the hierarchy), an entity can set up multiple templates where they are effectively modeling their business processes from a risk and control perspective.

Thus, the master structure 116 is a template to create business processes, the objectives of the business processes, the risks that would prevent achieving the objectives, and the controls that are designed to mitigate the risks. As will be described later, the system 100 allows an entity to create one or more location structures that may “subscribe” or “copy” a master structure 116. The reason an entity would choose to create master structures is that the entity may have one or more business processes that are homogeneous across the company's multiple locations. It is convenient to create these business processes as master structures just one time in the system and then have the locations subscribe to them.

The master structure 116 allows a user to specify or describe a process 120. Under the hierarchical structure, the process 120 falls under the master structure 116. The process 120 may include one or more sub-processes. The user may create multiple processes under the master structure 116, each process having one or more sub-processes.

For example, the process 120 may be a procurement process prescribed by the entity. The procurement process may be established by the entity to maintain control over requisitions of one or more items. The procurement process may be established by the entity to acquire goods and services. The process 120 may describe the procurement process that is followed by the entity.

The master structure 116 allows the user to specify or describe an objective 124 associated with the process 120. An objective for the procurement process discussed above may be to ensure that purchase orders are placed only for approved requisitions, i.e., to prevent unauthorized purchase orders. The user may describe a plurality of objectives. From a hierarchical perspective, the objective 124 is a child of the process 120.

The master structure 116 allows the user to specify or describe one or more risks 128 that may prevent achieving the objective 124. An example risk may be that an approved purchase order exceeds the maximum limit allowed for such purchases. From a hierarchical perspective, the risk is a child of the objective.

In one example embodiment, the user may specify the likelihood of the risk. For example, the user may indicate that the likelihood of the risk materializing is low, medium or high. The user may also indicate the magnitude of any damage caused if the risk were to materialize. For example, the magnitude of any damage may be low, medium of high. In one example embodiment, the likelihood of the risk and the magnitude of the risk may each be assigned a weight factor. The product of the weight factors (i.e., the likelihood of the risk and the magnitude of the risk) may be used to specify the importance of the particular process, objective and risk.

The master structure 116 allows the user to specify or describe one or more controls 132 to mitigate the risks. The controls 132 may include one or more control steps. For example, the control may provide that purchase requisitions are authorized prior to the creation of a purchase order. Also, the controls 132 may, for example, provide that any change to the purchase order approval limits is based upon the expenditure approval limit approved the Chief Financial Officer of the entity.

As discussed before, the control structure 112 allows the user to specify one or more location structures 136x . The location structures 136x each may, for example, represent a segment or a division of the entity located at a specific geographic location. The location structures 136x have the capability to subscribe to one or more components of the master structure 116. A particular location structure 136x may subscribe to the process 120 and the objectives 124 of the master structure 116, but may specify its own risks and controls. For example, the risk of leakage of hazardous chemicals may be higher at location #1 than the risk of leakage at locations #2 and #3. Accordingly, location #1, represented by a location structure 136x may subscribe to the same process and objectives as the master structure 116 but may choose to specify different risks and controls due to the higher risk of leakage of hazardous chemicals.

In one example embodiment, any change or modifications to one or more components of the master structure 116 causes a similar change to the corresponding components of the subscribing location structure 136x . Consider for example, a particular location structure 136x subscribes to the process 120, the objectives 124 and the risks 128 of the master structure 116. If there are changes made to the process 120, the objectives 124 and the risks 128, similar changes will occur to the process, objectives and risks of the locations structure 136x . Since the location structure 136x does not subscribe to the controls 132, any change to the controls 132 will not cause a corresponding change to the controls of the locations structure 132. In one example embodiment, a location structure 136x may “copy” the master structure. By copying the master structure 116, all components of the master structure will appear under the location structure. However, any change to the components of the master structure 116 will not translate into a change in corresponding location structure. Thus, if there are changes made to the master structure, the location structure will not be updated with the changes if the location structure merely copies the master structure but does not “subscribe” to the master structure.

In one example embodiment, the control structure 112 allows the user to specify one or more tests 140 to monitor the controls 132. The tests 140 indicate whether the control steps have been executed to mitigate the risks. For example, the user may specify a test 140 requiring that a purchase order register be reviewed by a purchasing manager on a weekly basis. The test may seek to verify that the purchase order register is sequentially numbered.

In one example embodiment, the control structure 112 allows the user to specify the frequency of the tests conducted and the importance of the tests. In one example embodiment, the control structure 112 allows the user to describe one or more gaps 144 within the controls. The gaps 144 are deficiencies in the controls. The user may specify remedial actions to cure the gaps. Once a gap has been cured or the appropriate remedial action has been taken, the user may indicate as such thus creating a record.

In one aspect, the gap 144 represents a problem that needs to be fixed. In one embodiment, gaps 144 can be created against processes, objectives, risks, controls and tests. However, gaps need not necessarily be associated with a process, objective, risk, control or test. Examples of gaps may include: (1) a process that has not been adequately described in the master structure; (2) a test that was not performed correctly; 3) a control that was tested and found to be ineffective (e.g., the accounting manager did not review and approve the bank reconciliations as he was required to do); (4) a risk that has no control identified to mitigate it.

In one example embodiment, the control structure 112 allows the user to specify the accounts impacted by the controls. For example, the procurement process may impact the accounts payable and cash account. Accordingly, the user may indicate these accounts, i.e., accounts payable and cash account, as being affected by the procurement process. This particular feature can be viewed as somewhat specific to compliance regimes dealing with financial reporting (e.g., Sarbanes-Oxley). In the system 100, the entity can establish its account structure. The benefit of mapping processes, objectives, risks, and controls to the accounts is that a user can see the impact of ineffective controls on the financial statements. The feature can also be used, however, for “statistical” accounts or “operational” accounts. If an entity has established a control structure in the system 100 for EPA risks and controls, the entity could establish a set of accounts that might include the key hazardous materials. The controls could be mapped to the hazardous materials that they relate to.

The system 100 generates one or more reports responsive to the user inputs. The system 100 includes a reporting engine that allows the user to ‘customize’ the datasets that comprise the reports. The system 100 includes one or more report templates. Each report template has an associated set of criteria fields that the user can use to define the dataset that will populate the report. Once the user defines the dataset in the criteria fields, the user can run the report. The report definition can be saves so that it can easily be run in the future. For example, the system 100 may generate a report listing the objectives of the master structure 116 or a location structure 136x . The report may, for example, list the risks of the master structure 116 or the location structure 136x and related controls. The report may include one or more charts or dash boards indicating the status of compliance with the control regimes.

In one example implementation, the system 100 includes charts that can be viewed online. These charts (or “chartlets”) are always updated in real time, that is, as the underlying data changes in the system 100, the charts are automatically updated. That charts indicate whether or not controls are operating effectively, results of testing and status of gaps. In one embodiment, the user can move the charts around on a dashboard. Each user can customize his own dashboard.

The report may indicate a master structure's or a location structure's percentage compliance with one or more controls. The report may also indicate a master structure's or a location structure's exposure to risk based on the compliance with one or more controls. The report may, for example, indicate whether certain controls are active or in remediation.

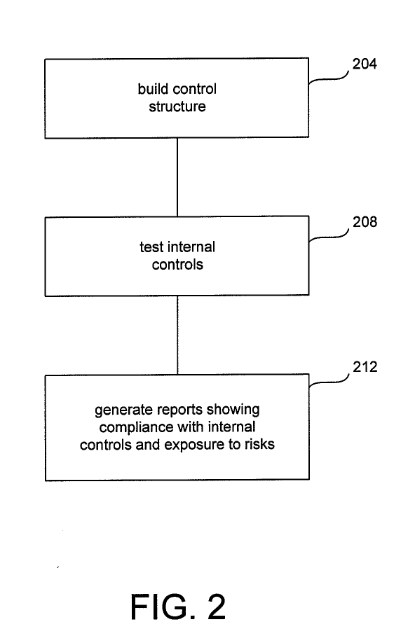

FIG. 2 is a high level flow diagram of the method steps in accordance with one example embodiment. In step 204, the user builds a control structure having a plurality of components as described above. As discussed before, the control structure allows the entity to establish internal controls to mitigate risks. In step 208, the internal controls are tested to determine compliance with the compliance regimes. In step 212, one or more reports are generated showing compliance with the internal controls and exposure to risks.

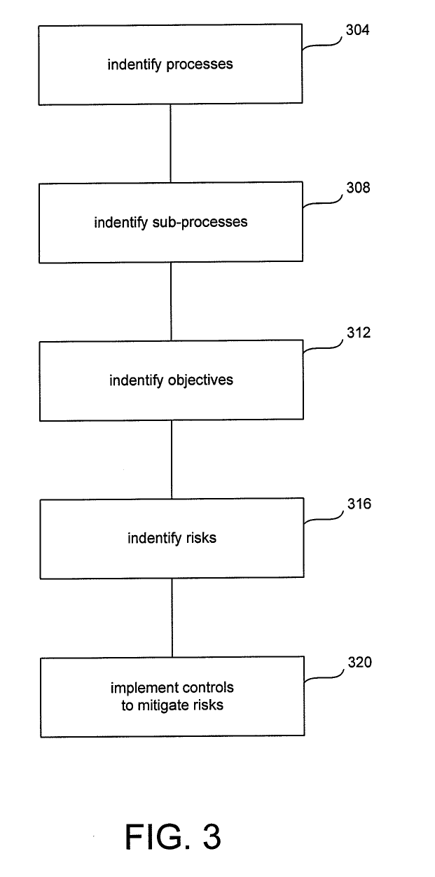

FIG. 3 is a detailed flow diagram of the method steps of establishing a master structure for compliance with one or more compliance regimes. In step 304, one or more processes are identified. In step 308, one or more sub-processes, if any are identified. In step 312, one or more objectives associated with each process (or sub-process) are identified. In one implementation, if there are sub-processes associated with a process, then objectives are associated only with the sub-processes, but not with the process. In step 316, one or more risks that may prevent achieving each objective is identified. As discussed before, the user may classify the likelihood of the risk and the magnitude of the effect if the risk materializes. Based on the user inputs, the importance of the risk can be determined. In one example embodiment, the importance of the risk is represented by the product of the likelihood of the risk and the magnitude of the impact. In step 320, one or more controls are implemented to mitigate the risks. The controls each include one or more control steps executed to mitigate the risks.

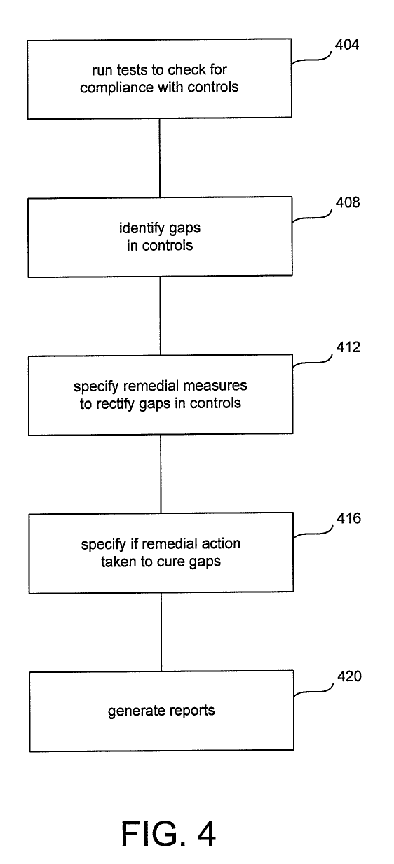

FIG. 4 is a flow diagram of the steps associated with conducting tests and generating reports in accordance with one example embodiment. In step 404, one or more tests are conducted to check whether the control steps have been executed to mitigate the risks. The user may specify the frequency of the tests conducted and the importance of the tests. In step 408, one or more gaps in the internal controls are identified. The gaps are deficiencies in the internal controls. In step 412, one or more remedial actions to cure the gaps may be specified. Once a gap has been cured or the appropriate remedial action has been taken, the user may indicate as such in step 416 thus creating a record.

In step 420, one or more reports responsive to the user inputs are generated. For example, a report listing the objectives and risks may be generated. The report may include one or more charts or dash boards indicating the entity's compliance status and exposure to risk based on the compliance status.

In one example implementation, a computer program product comprising a computer usable medium having computer readable program code embodied in the medium creates and manages internal controls for compliance with one or more compliance regimes by an entity. The computer readable program code executes a plurality of steps in accordance with internal controls set forth by the control structure.

The system, method, and computer program product, may, of course, be embodied in hardware; e.g., within or coupled to a Central Processing Unit (“CPU”), microprocessor, microcontroller, System on Chip (“SOC”), or any other programmable device. Additionally, the system, method, computer program product, and propagated signal may be embodied in software (e.g., computer readable code, program code, instructions and/or data disposed in any form, such as source, object or machine language) disposed, for example, in a computer usable (e.g., readable) medium configured to store the software. Such software enables the function, fabrication, modeling, simulation, description and/or testing of the apparatus and processes described herein. For example, this can be accomplished through the use of general programming languages (e.g., C, C++), GDSII databases, hardware description languages (HDL) including Verilog HDL, VHDL, AHDL (Altera HDL) and so on, or other available programs, databases, and/or circuit (i.e., schematic) capture tools. Such software can be disposed in any known computer usable medium including semiconductor, magnetic disk, optical disc (e.g., CD-ROM, DVD-ROM, etc.) and as a computer data signal embodied in a computer usable (e.g., readable) transmission medium (e.g., carrier wave or any other medium including digital, optical, or analog-based medium). As such, the software can be transmitted over communication networks including the Internet and intranets. A system, method, computer program product, and propagated signal embodied in software may be included in a semiconductor intellectual property core (e.g., embodied in HDL) and transformed to hardware in the production of integrated circuits. Additionally, a system, method, computer program product, and propagated signal as described herein may be embodied as a combination of hardware and software.

One of the implementations of the present invention is as a routine in an operating system made up of programming steps or instructions resident in a memory of a computing system as well known, during computer operations. Until required by the computer system, the program instructions may be stored in another readable medium, e.g. in a disk drive, or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media in a variety of forms.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, and the like. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a general purpose digital computer, software applications, routines and software modules, hardware including application specific integrated circuits, programmable logic devices, field programmable gate arrays, optical and other mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed is:

1. A system for creating and managing a control structure for compliance with one or more compliance regimes by an entity, the system operable to analyze risks associated with deficiencies in compliance and to generate reports related to the compliance, comprising:
a processor enabled to receive a plurality of user inputs, the inputs being related to the management of compliance and risks;
a memory connected to the processor and being responsive to the processor to store data received from the processor and to provide data to the processor;
the system, responsive to the user inputs, being operable to generate the control structure for:
specifying one or more master structures for the entity, wherein specifying the master structure comprises:
specifying one or more processes associated with the master structure;
specifying one or more objectives for the processes;
identifying one or more risks associated with the objective, the risk carrying a potential to prevent achieving the objectives;
identifying one or more controls to mitigate the risks, the control including one or more control steps executed to mitigate the risks.

2. The system of claim 1 being operable responsive to the user inputs to generate the control structure for specifying one or more location structures, each location structure having capability to subscribe to at least a portion of the master structure.

3. The system of claim 1 being operable responsive to the user inputs to generate data structures for modifying at least a portion of the master structure, wherein a modification of a portion of the master structure causes the system to modify the corresponding portion of the subscribing location structure.

4. The system of claim 1, wherein each location structure is associated with the entity and wherein the location structures are each located at a separate geographic location.

5. The system of claim 1 being operable responsive to the user inputs to generate data structures for specifying one or more tests for monitoring the controls, wherein the tests indicate whether the control steps have been executed to mitigate the risks.

6. The system of claim 5, wherein the tests generate outputs responsive to the user inputs, wherein the outputs indicate percentage compliance with the control regimes.

7. The system of claim 1 being operable responsive to the user inputs to generate data structures for specifying one or more gaps representing deficiencies.

8. The system of claim 7, wherein the gaps represent deficiencies in the processes, objectives and controls.

9. The system of claim 1, wherein one or more processes are sub-processes each.

10. The system of claim 1 being operable responsive to the user inputs to generate data structures for identifying one or more accounts impacted by the controls.

11. The system of claim 1 being operable responsive to the user inputs to generate data structures for specifying the likelihood of risk.

12. The system of claim 1 being operable responsive to the user inputs to generate data structures for specifying the magnitude of the risk, wherein the magnitude of the risk indicates the impact due to the realization of the risk.

13. The system of claim 1 being operable to determine the importance of the control from the likelihood of the risk and the magnitude of the risk.

14. The system of claim 1, wherein the compliance regime enforces compliance with securities laws or regulations.

15. The system of claim 1, wherein the compliance regime enforces compliance with financial reporting laws and regulations.

16. The system of claim 1, wherein the compliance regime enforces compliance with environmental laws and regulations.

17. The system of claim 1, wherein the compliance regime enforces compliance with labor and employment laws and regulations.

18. A computer-implemented method for establishing and managing a control structure for compliance with one or more compliance regimes by an entity, the method analyzing risks associated with deficiencies in compliance and generating reports related to the compliance, comprising:
specifying one or more master structures for the entity, wherein specifying the master structure comprises:
specifying one or more processes associated with the master structure;
specifying one or more objectives for the processes;
identifying one or more risks associated with the objective, the risk carrying a potential to prevent achieving the objectives;
identifying one or more controls to mitigate the risks, the control including one or more control steps executed to mitigate the risks.

19. The computer-implemented method of claim 18 further comprising specifying one or more location structures, each location structure having capability to subscribe to at least a portion of the master structure.

20. The computer-implemented method of claim 19 further comprising for modifying at least a portion of the master structure, wherein a modification of a portion of the master structure causes the system to modify the corresponding portion of the subscribing location structure.

21. The computer-implemented method of claim 19, wherein each location structure is associated with the entity and wherein the location structures are each located at a separate geographic location.

22. The computer-implemented method of claim 19 further comprising specifying one or more tests for monitoring the controls, wherein the tests indicate whether the control steps have been executed to mitigate the risks.

23. The computer-implemented method of claim 22, wherein the tests generate outputs responsive to inputs, wherein the outputs indicate percentage compliance with the control regimes.

24. The computer-implemented method of claim 19, further comprising specifying one or more gaps representing deficiencies.

25. The computer-implemented method of claim 24, wherein the gaps represent deficiencies in the processes, objectives or controls.

26. The computer-implemented method of claim 19, wherein one or more processes are sub-processes.

27. The computer-implemented method of claim 19 further comprising identifying one or more accounts impacted by the controls.

28. The computer-implemented method of claim 19 further comprising specifying the likelihood of risk.

29. The computer-implemented method of claim 19 further comprising specifying the magnitude of the risk, wherein the magnitude of the risk indicates the impact due to the realization of the risk.

30. The computer-implemented method of claim 19 further comprising determining the importance of the control from the likelihood of the risk and the magnitude of the risk.

31. The computer-implemented method of claim 19, wherein the compliance regime enforces compliance with securities laws or regulations.

32. The computer-implemented method of claim 19, wherein the compliance regime enforces compliance with financial reporting laws and regulations.

33. The computer-implemented method of claim 19, wherein the compliance regime enforces compliance with environmental laws and regulations.

34. The computer-implemented method of claim 19, wherein the compliance regime enforces compliance with labor and employment laws and regulations.

35. A method for creating and managing a control structure for compliance with one or more compliance regimes by an entity, the method utilizing a software application for providing analysis of risk associated with deficiencies in the compliance, the software application configured to receive a plurality of user inputs and responsive to the user inputs generating one or more outputs, the method comprising:
specifying one or more processes;
specifying one or more objectives for the processes;
identifying one or more risks associated with the objective, the risk carrying a potential to prevent achieving the objectives;
identifying one or more controls to mitigate the risks, the control including one or more control steps executed to mitigate the risks.

36. The method of claim 35 further comprising specifying one or more tests for monitoring the controls, wherein the tests indicate whether the control steps have been executed to mitigate the risks.

37. The method of claim 36, wherein the tests generate outputs responsive to inputs, wherein the outputs indicate percentage compliance with the control regimes.

38. The method of claim 36, further comprising specifying one or more gaps representing deficiencies.

39. The method of claim 38, wherein the gaps represent deficiencies in the processes, objectives or controls.

40. The method of claim 36, wherein one or more processes are sub-processes each having one or more sub-process steps executed to achieve the objectives.

41. The method of claim 36 further comprising identifying one or more accounts impacted by the controls.

42. The method of claim 36 further comprising specifying the likelihood of risk.

43. The method of claim 36 further comprising specifying the magnitude of the risk, wherein the magnitude of the risk indicates the impact due to the realization of the risk.

44. The method of claim 43 further comprising determining the importance of the control from the likelihood of the risk and the magnitude of the risk.

45. The method of claim 36, wherein the compliance regime enforces compliance with securities laws or regulations.

46. The method of claim 36, wherein the compliance regime enforces compliance with financial reporting laws and regulations.

47. The method of claim 36, wherein the compliance regime enforces compliance with environmental laws and regulations.

48. The method of claim 36, wherein the compliance regime enforces compliance with labor and employment laws and regulations.
